(19) United States
(12) Patent Application Publication
(10) Pub. No.: US 2014/0096612 A1
(43) Pub. Date: Apr. 10, 2014

(54) SYSTEM AND METHOD FOR DETECTING VIBRATION

(71) Applicant: GENERAL ELECTRIC COMPANY, Schenectady, NY (US)

(72) Inventors: Boris Leonid Sheikman, Minden, NV (US); David Robert O'Connor, Gardnerville, NV (US)

(73) Assignee: General Electric Company, Schenectady, NY (US)

(21) Appl. No.: 13/648,506

(22) Filed: Oct. 10, 2012

(51) Int. Cl. G01H 11/06

(52) U.S. Cl. 73/658

(57) ABSTRACT

A vibration detection system is provided. The vibration detection system includes a radio frequency (RF) source, a vibration sensor coupled to the RF source and configured to receive an RF signal supplied by the RF source and radiate RF energy, and a computing device coupled to said RF source and configured to calculate vibrational energy induced to the vibration sensor based on an impedance of the vibration sensor.

### BACKGROUND OF THE INVENTION

The subject matter disclosed herein relates generally to vibration detection systems, and more specifically, to a helical coil vibration sensor.

Known machines, such as gas turbines, include a plurality of moving components. During operation, the components may exhibit and/or generate vibrations in the machine. Such vibrations may be indicative of a failure of one or more components, or may lead to failure of one or more components. When left unchecked, vibrations can deteriorate and degrade equipment. Sensors may be used to monitor vibrations in order to determine the operational status of one or more components. For example, vibration sensors may measure an amount of vibrations induced in a motor drive shaft, a rotational position or displacement of the motor drive shaft, and/or other operational characteristics of a machine or motor.

At least some known vibration detection systems use a single coil of wire suspended around a permanent magnet as a vibration sensor. When the coil moves in response to a vibration, a current is induced in the coil as the coil passes through the magnetic field lines of the magnet. The current can be monitored to detect vibrations. However, at least some known vibration sensors are unable to detect relatively low frequency vibrations. Further, at least some known vibration sensors only generate a signal when a high frequency vibration is detected, and thus do not generate a detectable output when a low frequency vibration is present.

### BRIEF DESCRIPTION OF THE INVENTION

In one aspect, a vibration detection system is provided. The vibration detection system includes a radio frequency (RF) source, a vibration sensor coupled to the RF source and configured to receive an RF signal supplied by the RF source and radiate RF energy, and a computing device coupled to said RF source and configured to calculate vibrational energy induced to the vibration sensor based on an impedance of the vibration sensor.

In another aspect, a vibration sensor is provided. The vibration sensor includes a helical coil coupled to a radio frequency (RF) source and configured to radiate RF energy, and a mass coupled to and suspended from an end of the helical coil, wherein the mass facilitates extending and contracting the helical coil when the coil is exposed to vibrations, and wherein an inductance of the helical coil depends on a length of the helical coil.

In yet another aspect, a method for detecting vibration is provided. The method includes supplying a radio frequency (RF) signal to a vibration sensor, detecting impedance changes of the vibration sensor, and calculating vibrational energy induced to the vibration sensor based on the detected impedance changes.

### BRIEF DESCRIPTION OF THE DRAWINGS

FIG. 1 is a schematic diagram of an exemplary turbine assembly.

FIG. 2 is a schematic diagram of an exemplary vibration detection system that may be used with the turbine assembly shown in FIG. 1.

FIG. 3 is a block diagram of an exemplary computing device that may be used with the vibration detection system shown in FIG. 2.

FIGS. 4A-4C are exemplary graphs plotting detected power loss versus RF signal frequency in the vibration detection system shown in FIG. 2.

### DETAILED DESCRIPTION OF THE INVENTION

The systems and methods described herein enable the detection of vibrations of one or more components in a machine, such as a turbine assembly. The vibration detection system described herein includes a helical coil vibration sensor that uses a radio frequency (RF) source to radiate RF energy. By monitoring a power loss of the radiated energy, the expansion and compression of the helical coil, and accordingly, the magnitude of vibrations, can be determined.

Technical effects of the methods and systems described herein include at least one of (a) calculating power losses between an RF signal and radiated RF energy; (b) mapping the calculated power losses to a length of a helical coil in a vibration sensor; and (c) determining a vibrational frequency from oscillations in the length of the helical coil.

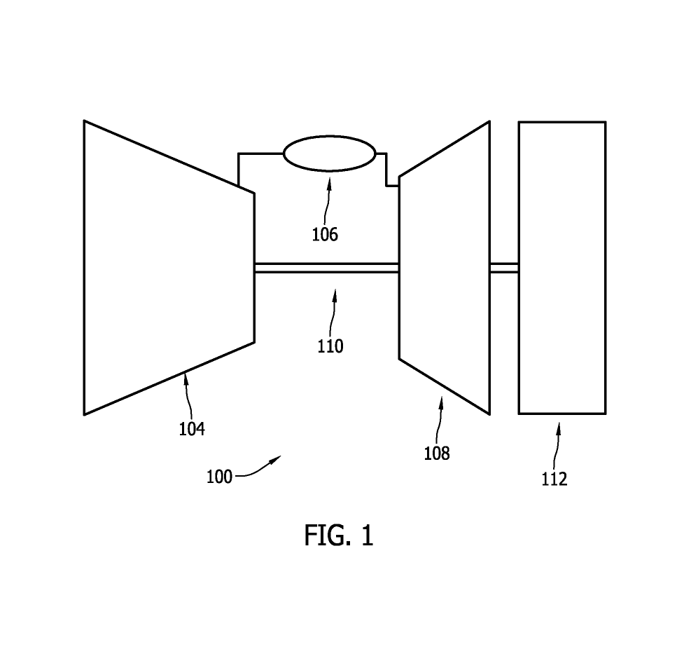

FIG. 1 is a schematic diagram of an exemplary turbine assembly 100. In the exemplary embodiment, turbine assembly 100 includes, coupled in a serial flow arrangement, a compressor 104, a combustor assembly 106, and a turbine 108 that is rotatably coupled to compressor 104 via a shaft 110.

During operation, in the exemplary embodiment, ambient air is channeled through an air inlet (not shown) towards compressor 104. The ambient air is compressed by compressor 104 prior it to being directed towards combustor assembly 106. In the exemplary embodiment, compressed air is mixed with fuel, and the resulting fuel-air mixture is ignited within combustor assembly 106 to generate combustion gases that are directed towards turbine 108. Moreover, in the exemplary embodiment, turbine 108 extracts rotational energy from the combustion gases and rotates shaft 110 to drive compressor 104. Furthermore, in the exemplary embodiment, turbine assembly 100 drives a load 112, such as a generator, coupled to shaft 110. In the exemplary embodiment, load 112 is downstream of turbine assembly 100. Alternatively, load 112 may be upstream from turbine assembly 100.

Vibrations generated during the operation of turbine assembly 100 may indicate the failure of at least one component and/or over time, may contribute to the failure of one or more components, which may require replacement and/or repair to ensure proper operation of turbine assembly 100. Accordingly, it may be advantageous to be able to detect and quantify vibrations occurring within turbine assembly 100.

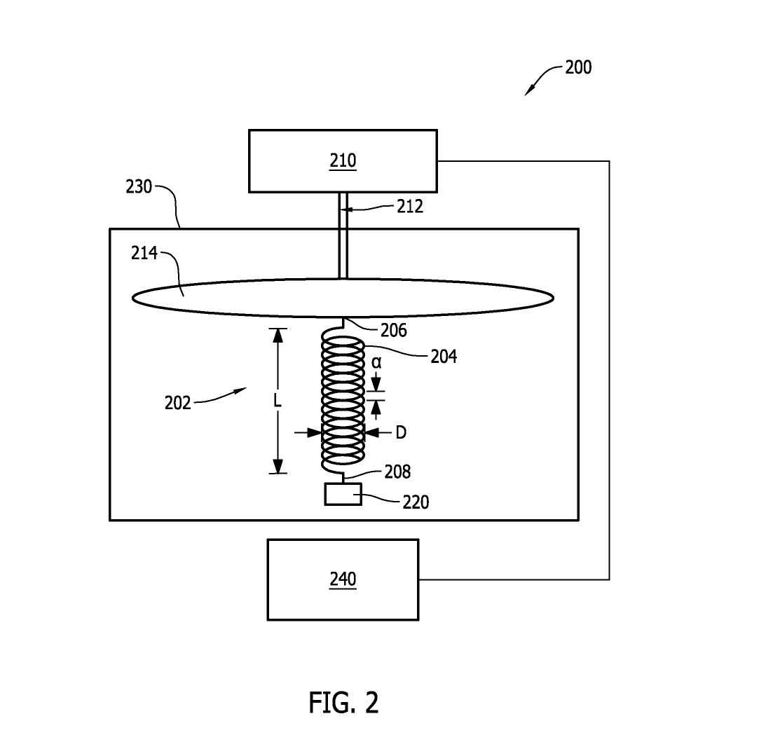

FIG. 2 is a schematic diagram of an exemplary vibration detection system 200 that may be used to detect vibrations generated in turbine assembly 100 (shown in FIG. 1), for example. Vibration detection system 200 may be mounted to, for example, a casing or component of turbine assembly 100. Vibration detection system 200 includes a vibration sensor 202 that includes a helical coil 204. Helical coil 204 includes a first end 206 and an opposite second end 208. In the exemplary embodiment, helical coil 204 is fabricated from a metal conductor. Alternatively, helical coil 204 may be made of any other material that enables vibration detection system 200 to function as described herein. To detect vibrations, helical coil 204 functions as a radiofrequency (RF) antenna, as is described in detail below.

In the exemplary embodiment, helical coil 204 has geometric properties that include a diameter D, a length L, a number of turns N, and a pitch a (i.e., a width of one complete turn). The electrical performance of helical coil 204 depends on the geometric properties. Accordingly, changing the geometric properties (e.g., length L, diameter D, turns N, pitch α, etc.) selectively changes the electrical performance of helical coil 204. The geometric properties of helical coil 204 also determine a resonant frequency of helical coil 204. In the exemplary embodiment, helical coil 204 has a resonant frequency of approximately 3.15 gigahertz (GHz). Alternatively, helical coil 204 may have any resonant frequency that enables vibration sensor 202 to function as described herein. For example, helical coil 204 may have a resonant frequency in a range from 500 megahertz (MHz) to 10 GHz.

Coil first end 206 is coupled to an RF source 210 that transmits an RF signal to helical coil 204. More specifically, RF source 210 is coupled to helical coil 204 using a cable 212. Cable 212 may be, for example, a 50 ohm coaxial cable. In the exemplary embodiment, RF source 210 is a signal generator that is capable of transmitting RF signals over a range of frequencies. Alternatively, RF source 210 may be any RF signal source that enables vibration sensor 202 to function as described herein. When the RF signal is supplied to helical coil 204 via RF source 210, helical coil 204 radiates RF energy. The RF signal supplied to helical coil 204 is an RF signal having substantially the same frequency as the resonant frequency of helical coil 204 in the exemplary embodiment. Alternatively, any RF signal that enables vibration sensor 202 to function as described herein may be transmitted to helical coil 204.

In the exemplary embodiment, an electrically-grounded reflector 214 is coupled at first end 206 of helical coil 204. Reflector 214 facilitates reflecting RF energy radiated from helical coil 204. In the exemplary embodiment, reflector 214 is a disc-shaped metallic plate. Alternatively, reflector 214 may have any shape and/or composition that enables vibration sensor 202 to function as described herein.

A mass 220 is coupled to, and hangs from, a second end 208 of helical coil 204 in the exemplary embodiment. Mass 220 is calibrated such that when it is in a rest position (i.e., with mass 220 and helical coil 204 in equilibrium), helical coil 204 is neither fully extended, nor fully compressed. During expansion, the length L of helical coil 204 is longer than the length L in the rest position. During compression, the length L of helical coil 204 is shorter than the length L in the rest position. To detect vibrations induced in a structure, such as one or more components of turbine assembly 100 (shown in FIG. 1), first end 206 is mounted to the associated structure. Accordingly, when the structure vibrates, mass 220 oscillates with respect to coil first end 206 as helical coil 204 expands and compresses. As such, mass 220 causes helical coil 204 to oscillate during vibrations. The degree of expansion and/or compression of helical coil 204 corresponds to the magnitude of the vibration.

As helical coil 204 expands and compresses in response to vibrations, an impedance of helical coil 204 changes. In the exemplary embodiment, coil 204 has an impedance of approximately 50 Ohms while coil 204 is at rest. Alternatively, helical coil may have any impedance that enables vibration sensor 202 to function as described herein. Because the impedance of helical coil 204 changes during expansion and/or compression, due to impedance mismatch, the power of RF energy radiated by helical coil 204 also changes.

Vibration sensor 202 is housed in an enclosure 230 that protects the components of vibration sensor 200 from damage and/or external interference. In the exemplary embodiment, to ensure vibration sensor 200 measures vibration in substantially one-dimension, enclosure 230 prevents movement of spring 204 and/or mass 220 in a direction perpendicular to the length L. To mount vibration sensor 202 to turbine assembly 100, enclosure 230 may be coupled to turbine assembly 100 using a bolt, threaded stud, and/or any suitable fastening mechanism.

As the impedance of helical coil 204 changes during expansion and/or compression of helical coil 204, the power reflected back to RF source 210 also changes. By measuring the transmitted and reflected power (i.e., the power loss), which is indicative of the impedance, a computing device 240 coupled to RF source 210 calculates an amount of vibrational energy detected by vibration sensor 202, as described in detail below.

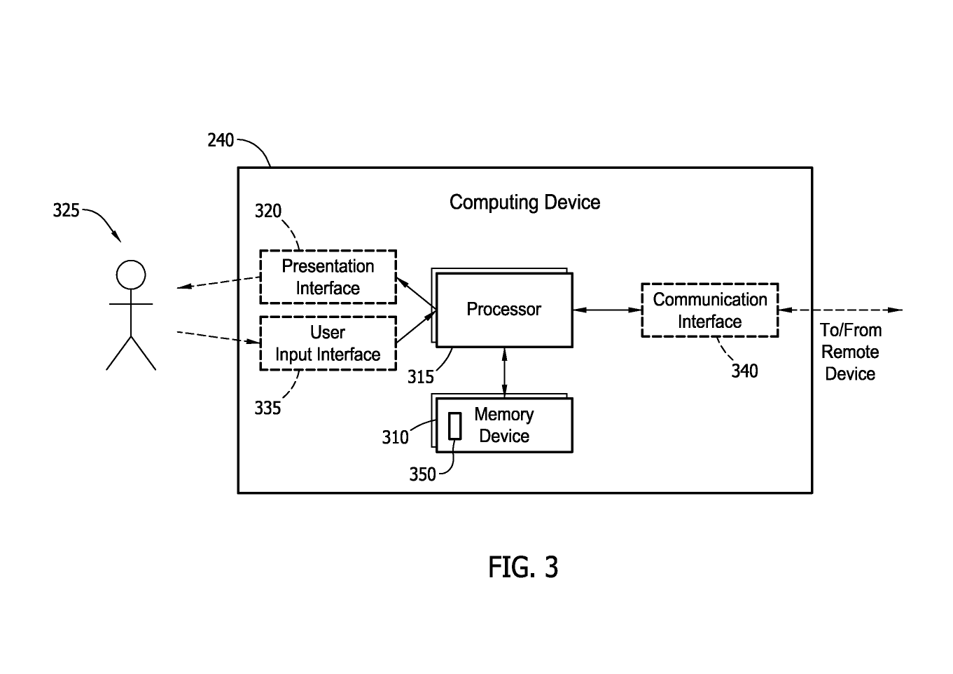

FIG. 3 is a block diagram of computing device 240. Computing device 240 includes at least one memory device 310 and a processor 315 that is coupled to memory device 310 for executing instructions. In some embodiments, executable instructions are stored in memory device 310. In the exemplary embodiment, computing device 240 performs one or more operations described herein by programming processor 315. For example, processor 315 may be programmed by encoding an operation as one or more executable instructions and by providing the executable instructions in memory device 310.

Processor 315 may include one or more processing units (e.g., in a multi-core configuration). Further, processor 315 may be implemented using one or more heterogeneous processor systems in which a main processor is present with secondary processors on a single chip. As another illustrative example, processor 315 may be a symmetric multi-processor system containing multiple processors of the same type. Further, processor 315 may be implemented using any suitable programmable circuit including one or more systems and microcontrollers, microprocessors, reduced instruction set circuits (RISC), application specific integrated circuits (ASIC), programmable logic circuits, field programmable gate arrays (FPGA), and any other circuit capable of executing the functions described herein.

In the exemplary embodiment, memory device 310 is one or more devices that enable information such as executable instructions and/or other data to be stored and retrieved. Memory device 310 may include one or more computer readable media, such as, without limitation, dynamic random access memory (DRAM), static random access memory (SRAM), a solid state disk, and/or a hard disk. Memory device 310 may be configured to store, without limitation, application source code, application object code, source code portions of interest, object code portions of interest, configuration data, execution events and/or any other type of data.

In some embodiments, computing device 240 includes a presentation interface 320 that is coupled to processor 315. Presentation interface 320 presents information, such as application source code and/or execution events, to a user 325. For example, presentation interface 320 may include a display adapter (not shown) that may be coupled to a display device, such as a cathode ray tube (CRT), a liquid crystal display (LCD), an organic LED (OLED) display, and/or an “electronic ink” display. In some embodiments, presentation interface 320 includes one or more display devices.

In the exemplary embodiment, computing device 240 includes a user input interface 335. In the exemplary embodiment, user input interface 335 is coupled to processor 315 and receives input from user 325. User input interface 335 may include, for example, a keyboard, a pointing device, a mouse, a stylus, a touch sensitive panel (e.g., a touch pad or a touch screen), a gyroscope, an accelerometer, a position detector, and/or an audio user input interface. A single component, such as a touch screen, may function as both a display device of presentation interface 320 and user input interface 335.

In some embodiments, computing device 240 includes a communication interface 340 coupled to processor 315. Communication interface 340 communicates with one or more remote devices. To communicate with remote devices, communication interface 340 may include, for example, a wired network adapter, a wireless network adapter, and/or a mobile telecommunications adapter. In the exemplary embodiment, unless otherwise noted, processor 315 calculates an amount of vibrational energy induced to vibration sensor 202, as described herein.

As noted above, the power in the RF energy radiated (and reflected) by helical coil 204 depends on the degree of extension and/or contraction of helical coil 204. Accordingly, in the exemplary embodiment, computing device 240 determines the amount of extension and compression of helical coil 204 based on the impedance change (e.g., by calculating the power loss). That is, computing device 240 determines the amount of vibration based on the impedance change. In the exemplary embodiment, computing device 240 calculates the power loss in decibels (dB). Alternatively, computing device 240 calculates the power loss in any units that enables vibration detection system 200 to function as described herein.

Computing device 240 maps or correlates the calculated power loss to the present length L (i.e., the degree of extension and/or contraction) of helical coil 204. The calculated power loss may be mapped to length L using a look-up table 350 or mathematical equation stored in memory device 310. Look-up table 350 includes a list of power losses and a corresponding length L associated with each power loss. Look-up table 350 may be generated from calibration measurements of vibration sensor 202.

For example, to generate an entry in look-up table 350, the power loss of helical coil 204 can be measured at the length L of the rest position. To generate additional entries, helical coil 204 is stretched and/or compressed to a known length L, and the corresponding power loss is measured. In one embodiment, a curve is fit to the power loss and length data to determine a functional relationship between power loss and length. This functional relationship can be utilized by computing device 240 to map the calculated power loss to the length L of helical coil 204. By tracking the power losses (and, accordingly, the length L of helical coil 204) over time, oscillations of helical coil 204 can be determined Such oscillations are indicative of the frequency of the vibrations that vibration sensor 202 experiences. In the exemplary embodiment, graphs plotting power loss versus coil length, power loss versus time, coil length versus time, and/or vibration frequency versus time may be displayed, for example, on presentation interface 320. Alternatively, any information that enables user 325 to determine the vibrations induced to vibration sensor 202 may be displayed on presentation interface 320.

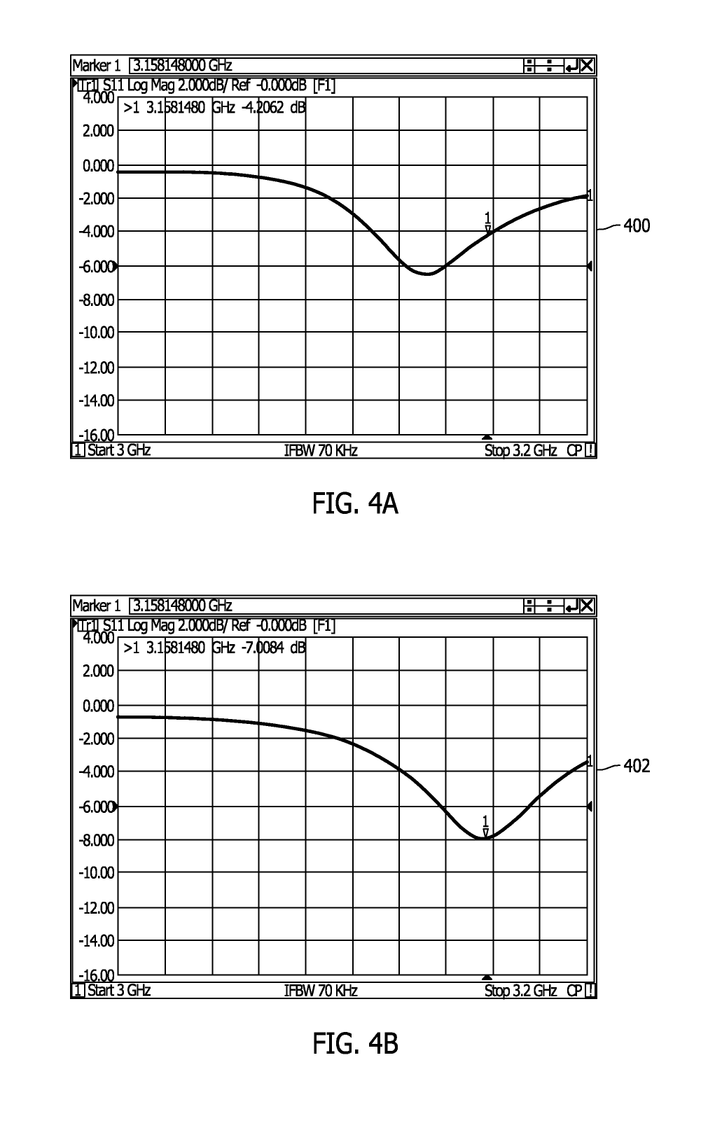

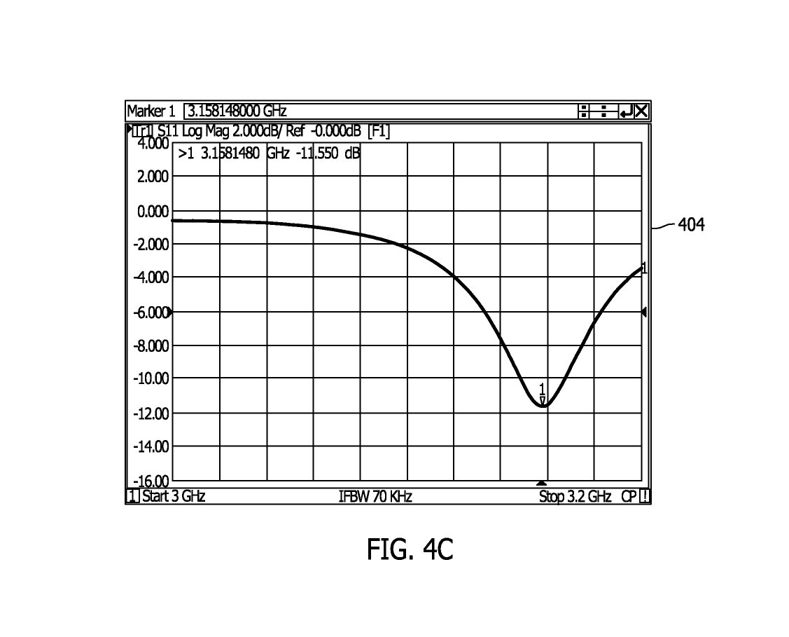

FIGS. 4A-4C are exemplary graphs plotting detected power loss versus RF signal frequency. As described above, in the exemplary embodiment, the RF signal has substantially the same frequency as the resonant frequency of helical coil 204.

FIG. 4A is a graph 400 plotting exemplary power losses versus RF signal frequency for vibration sensor 202 when helical coil 204 is in a compressed state (i.e., with a length L shorter than the length L in the rest position). As shown in FIG. 4A, at a resonant frequency of approximately 3.15 GHz, the measured power loss is approximately −4.2 dB.

FIG. 4B is a graph 402 plotting exemplary power losses versus RF signal frequency for vibration sensor 202 when helical coil 204 is in a neutral state (i.e., the rest position). As shown in FIG. 4B, at a resonant frequency of approximately 3.15 GHz, the measured power loss is approximately −7.9 dB.

FIG. 4C is a graph 404 plotting exemplary power losses versus RF signal frequency for vibration sensor 202 when helical coil 204 is in an expanded state (i.e., with a length L longer than the length L in the rest position). As shown in FIG. 4C, at a resonant frequency of approximately 3.15 GHz, the measured power loss is approximately −11.6 dB. Accordingly FIGS. 4A-4C illustrate that the power loss of vibration sensor 202 is dependent upon the length L of helical coil 204.

Notably, vibration detection system 200 (shown in FIG. 2) generates an output even when no vibrational energy is present in coil 204. Specifically, vibration detection system 200 measures a non-zero power loss even when helical coil 204 is in the rest position. Accordingly, as compared to at least some known vibration sensors that only generate an output during actual vibration, vibration detection system 200 always generates a measureable output. Further, vibration detection system 200 is capable of measuring lower frequency vibrations that at least some known vibration detection systems. For example, in some embodiments, vibration detection system 200 can detect vibrations as small as 0.5 hertz (Hz), or even detect a lack of vibration as a DC signal (i.e., 0 Hz).

The embodiments described herein enable the detection of vibrations of one or more components in a machine, such as a turbine assembly. The vibration detection system described herein includes a helical coil vibration sensor that uses a radio frequency (RF) source to radiate RF energy. By monitoring a power loss of the radiated energy, the expansion and compression of the helical coil, and accordingly, the magnitude of vibrations, can be determined.

Unlike at least some known vibration detection systems, the vibration detection system described herein can measure relatively low frequency vibrations and always generates a measureable output. Because the vibration detection system described herein always generates a measureable output, the vibration detection system described herein may be more responsive and/or accurate that at least some known vibration detection systems.

Exemplary embodiments of systems and methods for detecting vibrations are described above in detail. The systems and methods described herein are not limited to the specific embodiments described herein, but rather, components of the systems and/or steps of the methods may be utilized independently and separately from other components and/or steps described herein. For example, the vibration detection system described herein may be utilized in a plurality of machines, and is not limited to use with a turbine assembly.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A vibration detection system comprising:
a radio frequency (RF) source;
a vibration sensor coupled to said RF source and configured to:
receive an RF signal supplied by said RF source; and
radiate RF energy;
a computing device coupled to said RF source and configured to calculate vibrational energy induced to said vibration sensor based on an impedance of said vibration sensor.

2. A vibration detection system in accordance with claim 1, wherein said vibration sensor comprises:
a helical coil; and
a mass coupled to and suspended from an end of said helical coil, wherein said mass facilitates extending and contracting said helical coil when said coil is exposed to vibrations.

3. A vibration detection system in accordance with claim 2, wherein said computing device is configured to calculate an amount of vibrational energy induced to said vibration sensor by:
calculating power losses due to impedance changes in said helical coil;
mapping the calculated power losses to a length of said helical coil; and
determining a vibrational frequency from oscillations in the length of said helical coil.

4. A vibration detection system in accordance with claim 3, wherein said computing device is configured to map the calculated power losses to a length of said helical coil using a look-up table stored on said computing device, wherein said look-up table includes a list of power losses and associated helical coil lengths.

5. A vibration detection system in accordance with claim 2, wherein said vibration sensor further comprises an electrically-grounded reflector plate configured to reflect radiated RF energy.

6. A vibration detection system in accordance with claim 1, wherein the RF signal has a frequency that is approximately equal to a resonant frequency of said vibration sensor.

7. A vibration detection system in accordance with claim 1, wherein said vibration detection system is configured to detect a lack of vibration as a DC signal.

8. A vibration detection system in accordance with claim 1, wherein said vibration sensor has a resonant frequency of approximately 3.15 gigahertz.

9. A vibration detection system in accordance with claim 1, wherein said vibration sensor has an impedance of approximately 50 ohms in a rest position.

10. A vibration sensor comprising:
a helical coil coupled to a radio frequency (RF) source and configured to radiate RF energy; and
a mass coupled to and suspended from an end of said helical coil, wherein said mass facilitates extending and contracting said helical coil when said coil is exposed to vibrations, and wherein an inductance of said helical coil depends on a length of said helical coil.

11. A vibration sensor in accordance with claim 10, wherein said vibration sensor has a resonant frequency of approximately 3.15 gigahertz.

12. A vibration sensor in accordance with claim 10, wherein said vibration sensor has an impedance of approximately 50 ohms in a rest position.

13. A vibration sensor in accordance with claim 10, wherein said vibration sensor is mounted in a turbine assembly to detect vibrations in the turbine assembly.

14. A vibration sensor in accordance with claim 10, further comprising an electrically-grounded reflector plate configured to reflect the radiated RF energy.

15. A vibration sensor in accordance with claim 14, wherein said electrically-grounded reflector plate comprises a disc-shaped metallic plate.

16. A method for detecting vibration, said method comprising:
supplying a radio frequency (RF) signal to a vibration sensor;
detecting impedance changes of the vibration sensor; and
calculating vibrational energy induced to the vibration sensor based on the detected impedance changes.

17. A method in accordance with claim 16, wherein supplying an RF signal to a vibration sensor comprises supplying an RF signal having a frequency approximately equal to a resonant frequency of the vibration sensor.

18. A method in accordance with claim 16, wherein calculating vibrational energy comprises:
calculating power losses due to impedance changes in a helical coil in the vibration sensor;
mapping the calculated power losses to a length of a helical coil; and
determining a vibrational frequency from oscillations in the length of the helical coil.

19. A method in accordance with claim 18, wherein mapping the calculated power loss comprises mapping the calculated power loss using a look-up table that includes a list of power losses and associated helical coil lengths.

20. A method in accordance with claim 16, wherein supplying an RF signal to a vibration sensor comprises supplying an RF signal to a vibration sensor including a helical coil and a mass coupled to and suspended from an end of the helical coil to facilitate expanding and contracting the helical coil when the coil is exposed to vibrations.
